(19) United States
(12) Patent Application Publication
(10) Pub. No.: US 2024/0241692 A1
(43) Pub. Date: Jul. 18, 2024

(54) Sorting Method and Control for Partially Ordered Data Arrays in Embedded Systems

(71) Applicant: SK hynix Inc., Gyeonggi-do (KR)

(72) Inventors: Andrej GAVRILIN, Minsk (BY); Alexander ZAPOTYLOK, Minsk (BY)

(21) Appl. No.: 18/096,115

(22) Filed: Jan. 12, 2023

(51) Int. Cl. G06F 7/08; G06F 9/54; G06F 15/80

(52) U.S. Cl. CPC G06F 7/08; G06F 9/542; G06F 15/80

(57) ABSTRACT

A system having plural slave processors, with each slave processor configured to process at least one input data entry, and having a master processor configured to: a) receive input data entries output from the plural slave processors, b) store the input data entries in a list from a head to a tail of the list based on a time sequence, c) sort the input data entries by comparing a current input data entry with a first input data entry immediately preceding the current input data in a direction of the head of the list, and repeatedly insert the current input data into a first location immediately preceding the first input data entry or a second location immediately following the first input data entry in order to form a time-sequenced list of the data entries.

### BACKGROUND

### 1. Field

Embodiments of the present disclosure relate to sorting data log events.

### DESCRIPTION OF THE RELATED ART

As technologies grow, modern embedded systems, especially enterprise-level solutions, transform into large hi-speed and multi-core (or multi-processor) systems. On the one hand, average complexity of embedded solutions has increased significantly, and reaction time requirements have tightened on the other. The more sophisticated the solution is, the more difficult debugging and failure analysis become, so the NVMe specification v.1.4 introduces an additional Log Page for these purposes, referred to in the art as a persistent event log.

Previously, U.S. Pat. No. 11,294,743 (the entire contents of which are incorporated herein by reference) described firmware event tracking for NAND-based storage devices. In the '743 patent, a firmware event tracker was utilized which included a tracker event log in which events (occurring during execution of firmware) were recorded as event-items and stored in volatile or non-volatile memory.

### SUMMARY

In one embodiment of the present invention, there is provided a system having plural slave processors, with each slave processor configured to process at least one input data entry, and having a master processor configured to: a) receive input data entries output from the plural slave processors, b) store the input data entries in a list from a head to a tail of the list based on a time sequence, c) sort the input data entries by comparing a current input data entry with a first input data entry immediately preceding the current input data in a direction of the head of the list, and d) repeatedly insert the current input data into a first location immediately preceding the first input data entry or a second location immediately following the first input data entry in order to form a time-sequenced list of the data entries.

In one embodiment of the present invention, there is provided a method for sorting input data entries. The method receives the input data entries output from plural slave processors, stores the input data entries in a list from a head to a tail of the list based on a time sequence, sorts the input data entries by comparing a current input data entry with a first input data entry immediately preceding the current input data in a direction of the head of the list, and repeatedly inserts the current input data into a first location immediately preceding the first input data entry or a second location immediately following the first input data entry in order to form a time-sequenced list of the data entries.

Additional aspects of the present invention will become apparent from the following description.

### BRIEF DESCRIPTION OF THE DRAWINGS

FIG. 1 is a block diagram of an embedded system in accordance with one embodiment of the present invention;

FIG. 2 is a schematic showing the gathering of a complete log event in accordance with another embodiment of the present invention;

FIG. 3 is a schematic showing a data structure of an element of a doubly linked list in accordance with yet another embodiment of the present invention;

FIG. 4 is a schematic showing an output list of sorted elements in accordance with still another embodiment of the present invention;

FIG. 5 is a schematic showing an insertion event that takes a minimum of execution time;

FIG. 6 is a schematic showing an insertion event that does not take a minimum of execution time;

FIG. 7 is a flow chart of the inventive sorting algorithm;

FIG. 8A is a schematic showing experimental results from the inventive sorting algorithm;

FIG. 8B is a table showing the results of a number of operations spent per different algorithms, including the inventive sorting algorithm of FIG. 7; and

FIG. 9 is a flowchart illustrating a method for sorting partially ordered data in accordance with one embodiment of the present invention.

### DETAILED DESCRIPTION

Various embodiments are described below in more detail with reference to the accompanying drawings. The present invention may, however, be embodied in different forms and thus should not be construed as limited to the embodiments set forth herein. Rather, these embodiments are provided so that this disclosure is thorough and complete and fully conveys the scope of the present invention to those skilled in the art. Moreover, reference herein to “an embodiment,” “another embodiment,” or the like is not necessarily to only one embodiment, and different references to any such phrase are not necessarily to the same embodiment(s). Throughout the disclosure, like reference numerals refer to like parts in the figures and embodiments of the present invention.

The invention can be implemented in numerous ways, including as a process; an apparatus; a system; a computer program product embodied on a computer-readable storage medium; and/or a processor, such as a processor suitable for executing instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being suitable for performing a task may be implemented as a general component that is temporarily configured to perform the task at a given time or a specific component that is manufactured to perform the task. As used herein, the term ‘processor’ or the like refers to one or more devices, circuits, and/or processing cores suitable for processing data, such as computer program instructions.

A detailed description of embodiments of the invention is provided below along with accompanying figures that illustrate aspects of the invention. The invention is described in connection with such embodiments, but the invention is not limited to any embodiment. The scope of the invention is limited only by the claims. The invention encompasses numerous alternatives, modifications and equivalents within the scope of the claims. Numerous specific details are set forth in the following description in order to provide a thorough understanding of the invention. These details are provided for the purpose of example; the invention may be practiced according to the claims without some or all of these specific details. For clarity, technical material that is known in technical fields related to the invention has not been described in detail so that the invention is not unnecessarily obscured.

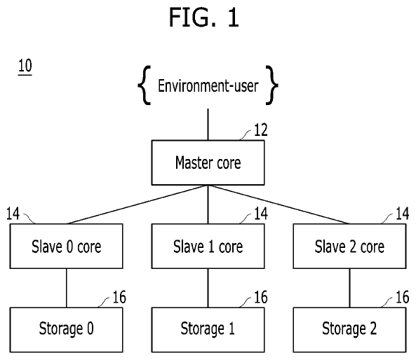

In one embodiment of the invention, one problem which the inventive method resolves is encountered during implementation of the persistent event log (noted above). The system of FIG. 1 is a multi-core embedded system 10 where there is a master core 12 in communication with slave cores 14 where each slave core 14 owns an independent private non-volatile memory storage 16 in which each slave core manages a dedicated set of NAND dies that belongs to this core only.

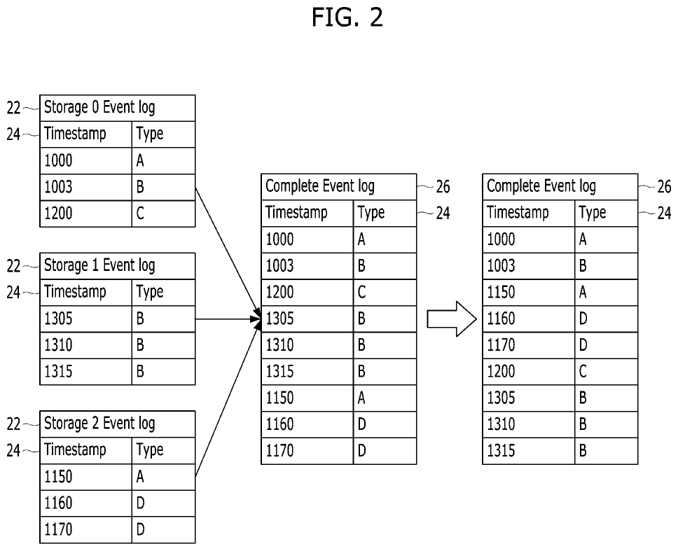

Slave cores 14 each have separate event logs 22 (such as shown in FIG. 2) for each non-volatile storage 16. Slave cores may comprise NAND storage devices, and the slave cores may be considered a source of input data entries that need to be sorted.

In one embodiment of the invention, the separate event logs 22 can be merged into one complete log on a user's demand. As shown in FIG. 2, event log entries 24, i.e. events, are supplied with timestamps, so the complete log can be correctly ordered in terms of a consistent chronology. Master core 12 can acquire the event logs 22 and merge the log entries 24 and associated timestamps to form the first complete event log 26 shown in FIG. 2. Master core 12 can sort the complete event log 26 by timestamps to form the second complete event log 26 shown in FIG. 2 (that is to form a time-sequenced list of the data entries).

In one aspect of the invention, each event log 22 is, most likely, ordered properly within its local scope (time frame), as the event logs 22 in FIG. 2 are shown. This results in ordered areas in the first merged complete log 26 which are ‘partially ordered’ before actual sorting by master core 12. Block and paginated structure of NAND flash memory (the most demanded non-volatile memory type at the moment) may produce even more ordered areas within each storage unit 16, resulting in more partially ordered events than shown in FIG. 2.

Event log entries in the storage event logs 22 may be of a variable size, which is specific to a persistent event log page. This fact restricts in-place element swapping in any implementation of a sorting algorithm, and additional memory resources and execution time are required to overcome this complication. Embedded software for the sorting may be restricted by response time. As a consequence, sorting experimentation on the biggest possible data size with the data patterns (for example) as described above revealed timeout deficiencies.

Specifically, it was discovered that well-known sorting algorithms (e.g., selection sort, bubble sort, insertion sort, etc.) were not suitable, as timeout requirements were not met. An average sort time with the well-known sorting algorithms lies between 1 and 4 minutes, and timeout is 30 sec. Meanwhile, the inventive sorting method (as detailed below) showed a result of 15 seconds on average.

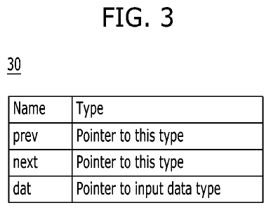

The inventive sorting procedure in one embodiment of the invention produces a doubly linked list 30 of input elements (as seen in FIG. 3), sorted in the ascending order; if the descending order is needed, the list may be iterated from the tail. Input data may be iterated only once, all elements are processed one by one, and the final position in the output list is determined upon completion of the processing. There is no element swapping in the output list or input data. Instead, insertion into output list is used.

In other words, the sorting procedure takes an array of event entries as input and produces a doubly linked list from the same data. The purpose is to make swap operations more effective as well as to reduce the number of swap operations.

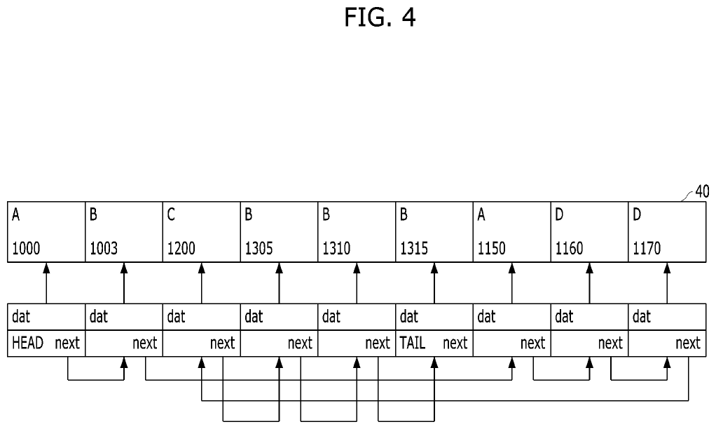

FIG. 4 shows the resulting list 40 for the input data shown above in FIG. 2. The inventive method inserts a data element into the appropriate time-position, to the ‘left’ or to the ‘right’, relative to the last inserted element. The inventive method seeks a time position to the ‘left’, if the inserting element is less (in time) than the last inserted one. The inventive method seeks a time position to the ‘right’, if the inserting element is greater (in time) than the last inserted element.

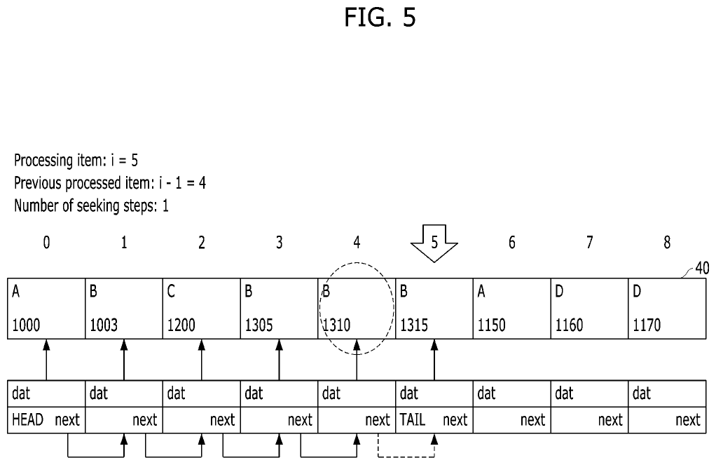

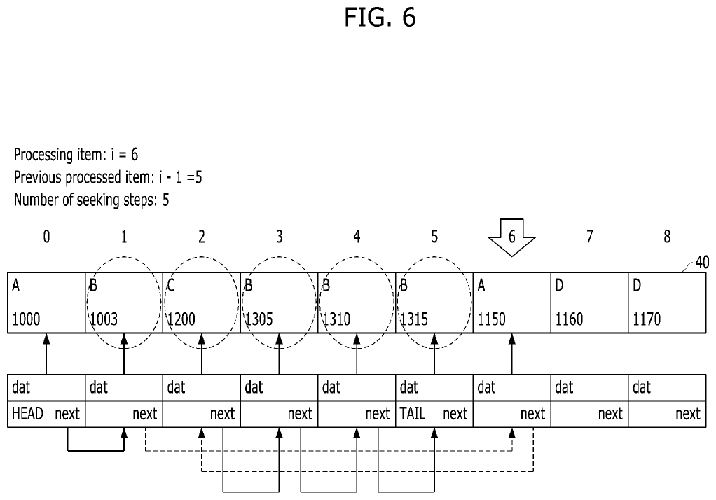

FIG. 5 is a schematic showing an insertion event that takes a minimum execution time. In this illustration, since the input to the inventive sorting algorithm contains long sequences of properly ordered data elements (groups of properly ordered data elements), seeking for an appropriate time position for the inserting element minimizes execution time, because a properly ordered group of data elements goes next to the last inserted element (see processing item number 5 in FIG. 5 where the number of seeking steps is “1”). In this sorting operation of FIG. 5, the timestamps 1310, a tail pointer identifying the last data element in time to be sorted, and a head pointer identifying the first data element in time to be sorted may be used. Meanwhile, FIG. 6 is a schematic showing an insertion event that does not take a minimum of execution time. A non-minimum execution time is consumed for all the cases before another ordered group of data elements in the input is reached (see processing item number 6 in FIG. 6 where the number of seeking steps is “5”).

### Inventive Sorting Method

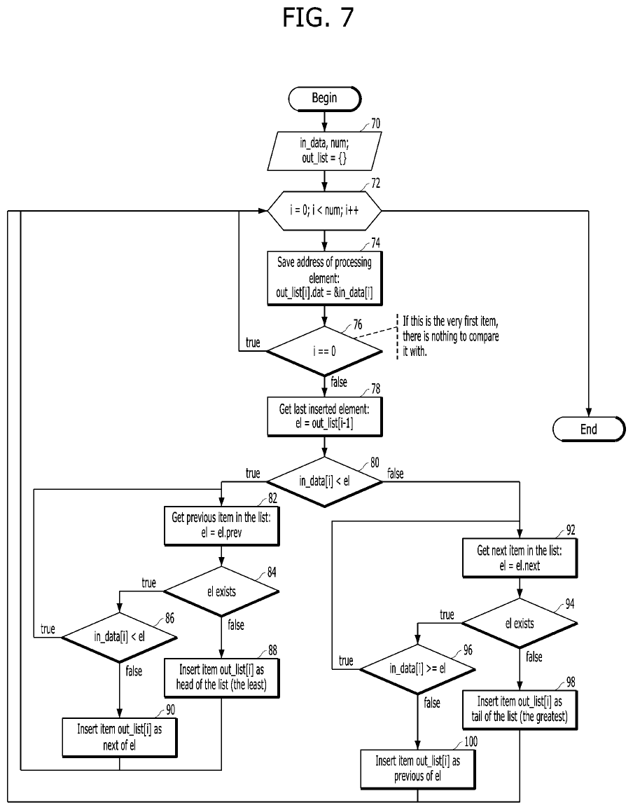

Details of the inventive sorting method are shown in FIG. 7, with the steps shown are examples of code in a C-like meta-language.

As shown in FIG. 7, at 70, input data is supplied in the form of an array with the size of the array (“num”) provided. At 72, a decision is made whether the process proceeds to 74 where the address of the element being processed is saved. More specifically, at 72, a “FOR” loop is executed: with initial index (i) value=0, index (i) steps up while it is less than size (“num”), index steps up by one (i++). At 76, a decision is made if this is the first item being processed, in which case there is nothing to compare with regard to the timestamp of the first item being processed. At 76, the process proceeds to 78 when there has been a prior item processed. At 78, the address of the last inserted item is obtained. At 80, if the input data of the item being processed has a timestamp less than the last inserted item, the process proceeds to 82 where the address of the previous item is obtained and saved in pointer el. That is now pointer el contains the address of the previous item. At 84, a determination is made if the previous item actually exists. If the pointer does not exist, at 88, the item being processed is inserted as the head of the list. If the pointer does exist, at 86, the timestamp of the item being processed is compared to the timestamp of the previous item. At 86, if the timestamp of the item being processed is not less than the timestamp of the previous item, then at 90, the item being processed is inserted as the next element the “el” pointer points to. At 86, if the timestamp of the item being processed is less than the timestamp of the previous item, then loop returns to 82 for comparing to yet a previous item.

If at 80 the input data of the item being processed has a timestamp that is not less than the last inserted item, the process proceeds to 92 where the address of the next item in the list is obtained. At 94, a determination is made if the next item actually exists. That is if the address of the previous element is not equal to NULL it exists, and if address is equal to NULL the address of the previous element does not exist (the tail of list is reached). If the pointer does not exist, then at 98 the item being processed is inserted as the tail of the list. If the pointer does exist, then at 96 the item being processed is compared to the timestamp of the next item. At 96, if the timestamp of the item being processed is not greater than the timestamp of the next item, then at 100 the item being processed is inserted as the previous element that the “el” pointer points to. At 96, if the timestamp of the item being processed is greater than the timestamp of the next item, then loop returns to 92 for comparing to yet a next item. The loop return at 86 and the loop return at 96 determine where a current item being processed should be inserted correctly into a time-sequenced list of the data entries.

In other words, the inventive algorithm of FIG. 7 a) sorts the input data entries by comparing a current input data entry with a first input data entry immediately preceding the current input data in a direction of the head of the list and b) repeatedly inserts the current input data (the items being processed) into a first location immediately preceding the first input data entry or a second location immediately following the first input data entry in order to form the time-sequenced list of the data entries.

### Experimental Results

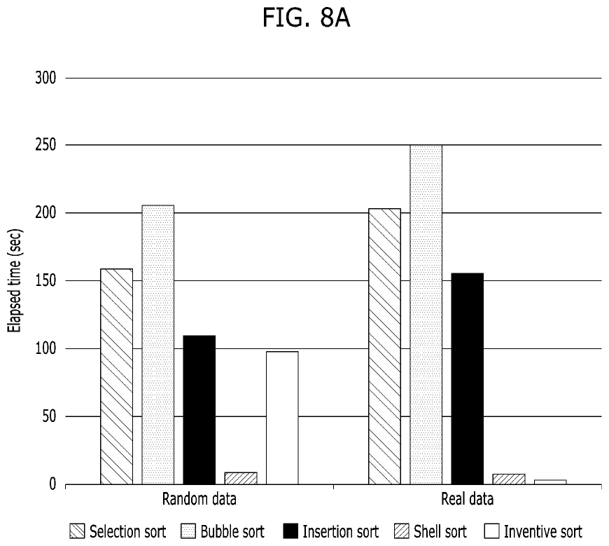

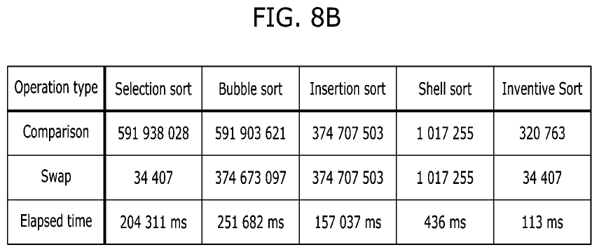

FIG. 8A is a depiction of the results of using the inventive algorithm of FIG. 7. All experiments were conducted on the maximum allowed log size, i.e., the worst case. Real log data, which matches the partially ordered data pattern described in FIG. 2, and random data pattern were used in these experiments. An average time spent by known sorting algorithms and the inventive algorithm of FIG. 7 is shown in FIG. 8A. The lower values represent better performance. The depiction in FIG. 8A shows the improved performance of the inventive algorithm, especially when real data (i.e., data as in FIG. 2), which is already partially ordered, is used.

Additional experiments were conducted on real log data in order to understand the nature of the results. The number of swap operations and comparison operations per each sorting algorithm were counted up. Both operation types are non-atomic operations (that a complier can split into multiple operations); involved memory type is DRAM. FIG. 8B shows the results of the number of operations spent per each algorithm in the table depicted there. The results in FIG. 8B shown that the inventive algorithm of FIG. 7 requires a fewer number of comparisons and occurs quicker than the convention approaches depicted there, especially for partially ordered data.

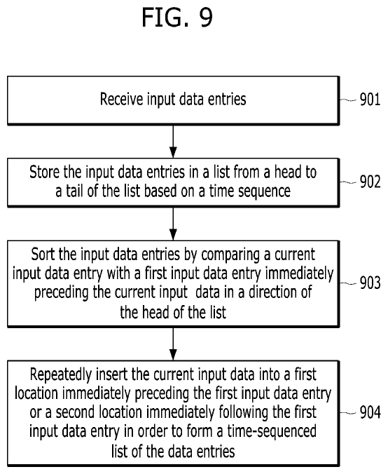

FIG. 9 is a flowchart illustrating a method for sorting input data entries in a master processor. The method at 901 receives the input data entries output from (preferably but not necessarily) plural slave processors. The method at 902, stores (preferably but not necessarily) in the master processor the input data entries in a list from a head to a tail of the list based on a time sequence. The method at 903, sorts (preferably but not necessarily) in the master processor the input data entries by comparing a current input data entry with a first input data entry immediately preceding the current input data in a direction of the head of the list. The method at 904 repeatedly inserts the current input data into a first location immediately preceding the first input data entry or a second location immediately following the first input data entry in order to form a time-sequenced list of the data entries.

The method at 904 may insert the current input data into the first location immediately preceding the first input data entry when the current input data entry is ahead of the first input data entry. The method at 904 may append the current input data entry into the second location following the first input data entry when the first input data entry is ahead of the current input data entry.

The method of FIG. 9 may receive for the input data entries partially time-ordered data entries, and the master processor may sort the partially time-ordered data entries. In this method, the input data entries may comprise storage event logs from each of the plural slave processors, and the storage event logs may comprise a timestamp for each event recorded therein. In this method, the master processor may compile an output list from the storage event logs, and the output list may comprise the time-sequenced list of the data entries. In this method, the output list may not (necessarily be) formed by element swapping in the output list or input data. Instead, in the method of FIG. 9, the output list may be formed by insertion of individual input data from the input data entries into the output list.

In one embodiment of the invention, there is provided a system (such as the system of FIG. 1) comprising plural slave processors, each slave processor configured to process at least one input data entry, and comprising a master processor configured to: a) receive input data entries output from the plural slave processors, b) store the input data entries in a list from a head to a tail of the list based on a time sequence, c) sort the input data entries by comparing a current input data entry with a first input data entry immediately preceding the current input data in a direction of the head of the list, and d) repeatedly insert the current input data into a first location immediately preceding the first input data entry or a second location immediately following the first input data entry in order to form a time-sequenced list of the data entries.

In this system, the master processor may be configured to insert the current input data into the first location immediately preceding the first input data entry when the current input data entry is ahead (in time) of the first input data entry. In this system, the master processor may be configured to append the current input data entry into the second location following the first input data entry when the first input data entry is ahead (in time) of the current input data entry.

In this system, the master processor may be configured to receive (for the input data entries) partially time-ordered data entries, and the master processor may be configured to sort the partially time-ordered data entries.

In this system, the master processor may be configured to receive for the input data entries storage event logs from each of the plural slave processors. The storage event logs may comprise a timestamp for each event recorded therein. In this system, the master processor may be configured to compile an output list from the storage event logs, and the output list may comprise the time-sequenced list of the data entries. In this system, the output list is not (necessarily) formed by element swapping in the output list or input data. Instead, the output list may be formed by insertion of individual input data from the input data entries into the output list.

Although the foregoing embodiments have been illustrated and described in some detail for purposes of clarity and understanding, the present invention is not limited to the details provided. There are many alternative ways of implementing the invention, as one skilled in the art will appreciate in light of the foregoing disclosure. The disclosed embodiments are thus illustrative, not restrictive. The present invention is intended to embrace all modifications and alternatives recognized by one skilled in the art.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, or a combination of one or more of them. Apparatus, devices, and machines for processing data in the invention can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network. The computer program can be embodied as a computer program product as noted above containing a computer readable medium.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be excised from the combination, and the combination may be directed to a sub-combination or variation of a sub-combination.

What is claimed is:

1. A system comprising:
plural slave processors, each slave processor configured to process at least one input data entry; and
a master processor configured to:
receive input data entries output from the plural slave processors,
store the input data entries in a list from a head to a tail of the list based on a time sequence,
sort the input data entries by comparing a current input data entry with a first input data entry immediately preceding the current input data in a direction of the head of the list, and
repeatedly insert the current input data into a first location immediately preceding the first input data entry or a second location immediately following the first input data entry in order to form a time-sequenced list of the data entries.

2. The system of claim 1, wherein the master processor is configured to insert the current input data into the first location immediately preceding the first input data entry when the current input data entry is ahead of the first input data entry.

3. The system of claim 1, wherein the master processor is configured to append the current input data entry into the second location following the first input data entry when the first input data entry is ahead of the current input data entry.

4. The system of claim 1, wherein the master processor is configured to receive for the input data entries partially time-ordered data entries.

5. The system of claim 4, wherein the master processor is configured to sort the partially time-ordered data entries.

6. The system of claim 1, wherein the master processor is configured to receive for the input data entries storage event logs from each of the plural slave processors.

7. The system of claim 6, wherein the storage event logs comprise a timestamp for each event recorded therein.

8. The system of claim 6, wherein the master processor is configured to compile an output list from the storage event logs, and the output list comprise the time-sequenced list of the data entries.

9. The system of claim 8, wherein the output list is not formed by element swapping in the output list or input data.

10. The system of claim 9, wherein the output list is formed by insertion of individual input data from the input data entries into the output list.

11. A method for sorting input data entries, comprising:
receiving the input data entries output from plural slave processors;
storing the input data entries in a list from a head to a tail of the list based on a time sequence;
sorting the input data entries by comparing a current input data entry with a first input data entry immediately preceding the current input data in a direction of the head of the list; and
repeatedly inserting the current input data into a first location immediately preceding the first input data entry or a second location immediately following the first input data entry in order to form a time-sequenced list of the data entries.

12. The method of claim 11, wherein the repeatedly inserting inserts the current input data into the first location immediately preceding the first input data entry when the current input data entry is ahead of the first input data entry.

13. The method of claim 11, wherein the repeatedly inserting appends the current input data entry into the second location following the first input data entry when the first input data entry is ahead of the current input data entry.

14. The method of claim 11, wherein the receiving the input data entries comprises receiving for the input data entries partially time-ordered data entries.

15. The method of claim 14, wherein the master processor sorts the partially time-ordered data entries.

16. The method of claim 11, wherein the receiving the input data entries comprises receiving for the input data entries storage event logs from each of the plural slave processors.

17. The method of claim 16, wherein the storage event logs comprise a timestamp for each event recorded therein.

18. The method of claim 16, wherein the master processor compiles an output list from the storage event logs, and the output list comprise the time-sequenced list of the data entries.

19. The method of claim 18, wherein the output list is not formed by element swapping in the output list or input data.

20. The method of claim 19, wherein the output list is formed by insertion of individual input data from the input data entries into the output list.
